(19) United States
(12) Patent Application Publication
(10) Pub. No.: US 2019/0277464 A1
(43) Pub. Date: Sep. 12, 2019

(54) Light Fixture Locking System and Method

(71) Applicant: Danniell H. Won, Riverdale, NJ (US)

(72) Inventor: Danniell H. Won, Riverdale, NJ (US)

(21) Appl. No.: 15/915,952

(22) Filed: Mar. 8, 2018

(51) Int. Cl. F21S 8/02; F21V 8/00; F21V 23/00

(52) U.S. Cl. CPC F21S 8/026; G02B 6/0088; F21Y 2115/10; F21V 23/003; G02B 6/0083; G02B 6/0051

(57) ABSTRACT

A catch mechanism has a resilient member; and an engagement member having: a top portion pivotally engaging a fastener which pivotally fastens the engagement member to a side wall of a light fixture; and a catch member extending substantially vertically from the top portion and including: a side wall portion engaging the resilient member; and a bottom portion engaging a light fixture support member; wherein the resilient member applies a restorative force to the catch member to bias the catch member away from the side wall to cause the bottom portion of the catch member to engage the light fixture support member.

### BACKGROUND OF THE INVENTION

### 1. Field of the Invention

The present invention relates to a light fixture, and in particular to a light fixture capable of being installed in a ceiling, especially in zero-plenum ceilings.

### 2. Description of Prior Art

Light fixtures, which are also known as light fittings or luminaires, may be mounted in a ceiling; for example, within or among ceiling tiles to provide overhead lighting in facilities such as building interiors.

Typically, an installer of the light fixture must use a tool such as a screwdriver to insert and secure a fastener, such as a screw, in the light fixture while, at the same time, holding the light fixture in place as well as holding and using the tool and any fastener. Such installation processes are cumbersome and may require multiple installers, which increases the costs of installation. In addition, removal of an installed light fixture can also be cumbersome as well as time-consuming.

A need exists of a simple method for installing and removing ceiling-based light fixtures.

In the prior art as described in U.S. Pat. No. 9,726,339 B2 to Hierzer, a support structure has profile elements, and a luminaire has catches, such that the luminaire is inserted between the profile elements until the catches snap into place to engage the profile elements. The catches are spring-loaded with a pivot axis parallel to the longitudinal length of the luminaire. In addition, the luminaire is set in the ceiling at one level, with portions of the luminaire being exposed.

One problem with such prior art luminaires is that they are not adjustable for height. Furthermore, removal of such prior art luminaires is that they are difficult to remove without using special tools. A need exists for an improved light fixture or luminaire.

### OBJECTS AND SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention includes a catch mechanism having: a resilient member; and an engagement member having: a top portion pivotally engaging a fastener which pivotally fastens the engagement member to a side wall of a light fixture; and a catch member extending substantially vertically from the top portion and including: a side wall portion engaging the resilient member; and a bottom portion engaging a light fixture support member; wherein the resilient member applies a restorative force to the catch member to bias the catch member away from the side wall to cause the bottom portion of the catch member to engage the light fixture support member.

A pivot axis of the top portion is substantially perpendicular to a longitudinal length of the light fixture. The fastener is a screw for pivotally fastening the top portion of the engagement member to the side wall. The fastener retains the resilient member proximate to the side wall. In one embodiment, the catch member has a vertical dimension with a length to cause the light fixture to be substantially recessed within a ceiling. In another embodiment, the catch member has a vertical dimension with a length to cause the light fixture to be partially recessed within a ceiling. In a further embodiment, the catch member has a vertical dimension with a length to cause the light fixture to not be recessed within a ceiling.

The present invention also includes a light fixture having a base having a side wall; lighting electronics mounted on the base; and a catch mechanism including: a resilient member; an engagement member having: a top portion pivotally engaging a fastener which pivotally fastens the engagement member to the side wall; and a catch member extending substantially vertically from the top portion and including: a side wall portion engaging the resilient member; and a bottom portion engaging a light fixture support member; wherein the resilient member applies a restorative force to the catch member to bias the catch member away from the side wall to cause the bottom portion of the catch member to engage the light fixture support member.

A pivot axis of the top portion is substantially perpendicular to a longitudinal length of the light fixture. The fastener is a screw for pivotally fastening the top portion of the engagement member to the side wall. The fastener retains the resilient member proximate to the side wall. In one embodiment, the catch member has a vertical dimension with a length to cause the light fixture to be substantially recessed within a ceiling. In another embodiment, the catch member has a vertical dimension with a length to cause the light fixture to be partially recessed within a ceiling. In a further embodiment, the catch member has a vertical dimension with a length to cause the light fixture to not be recessed within a ceiling.

The present invention also includes an assembly having: a base having a side wall; lighting electronics mounted on the base; a fastener; a resilient member; and a catch mechanism including: an engagement member having: a top portion pivotally engaging the fastener which pivotally fastens the engagement member to the side wall; and a catch member extending substantially vertically from the top portion and including: a side wall portion engaging the resilient member; and a bottom portion engaging a light fixture support member; wherein the resilient member applies a restorative force to the catch member to bias the catch member away from the side wall to cause the bottom portion of the catch member to engage the light fixture support member.

A pivot axis of the top portion is substantially perpendicular to a longitudinal length of the light fixture. The fastener retains the resilient member proximate to the side wall. In one embodiment, the catch member has a vertical dimension with a length to cause the light fixture to be substantially recessed within a ceiling. In another embodiment, the catch member has a vertical dimension with a length to cause the light fixture to be partially recessed within a ceiling. In a further embodiment, the catch member has a vertical dimension with a length to cause the light fixture to not be recessed within a ceiling.

### BRIEF DESCRIPTION OF THE DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a top front perspective view of a fixture of the present invention;

FIG. 2 is a top plan view of the fixture of FIG. 1;

FIG. 3 is a bottom plan view of the fixture of FIG. 1;

FIG. 4 is a side plan view of the fixture of FIG. 1;

FIG. 5 is a bottom front perspective view of the fixture of FIG. 1;

FIG. 6 is a front plan view of the fixture of FIG. 1;

FIG. 7 is a top front perspective view of a portion of a catch mechanism of the present invention;

FIG. 8 is a top front perspective view of a resilient member of the catch mechanism of FIG. 7;

FIG. 9 is a top front perspective view of an engagement member of the catch mechanism of FIG. 7;

FIG. 10 is a front plan view of the fixture in a fully recessed configuration;

FIG. 11 is a front plan view of the fixture in a partially recessed configuration;

FIG. 12 is a front plan view of the fixture in a surface mounted configuration; and

FIG. 13 is a partial sectional view of the fixture of FIG. 6.

To facilitate an understanding of the invention, identical reference numerals have been used, when appropriate, to designate the same or similar elements that are common to the figures. Further, unless stated otherwise, the features shown in the figures are not drawn to scale, and instead are shown for illustrative purposes only.

### DETAILED DESCRIPTION OF THE PREFERRED EMBODIMENTS

Certain terminology is used in the following description for convenience only and is not limiting. The article “a” is intended to include one or more items, and where only one item is intended the term “one” or similar language is used. Additionally, to assist in the description of the present invention, words such as top, bottom, upper, lower, front, rear, inner, outer, right and left are used to describe the accompanying figures. The terminology includes the words above specifically mentioned, derivatives thereof, and words of similar import.

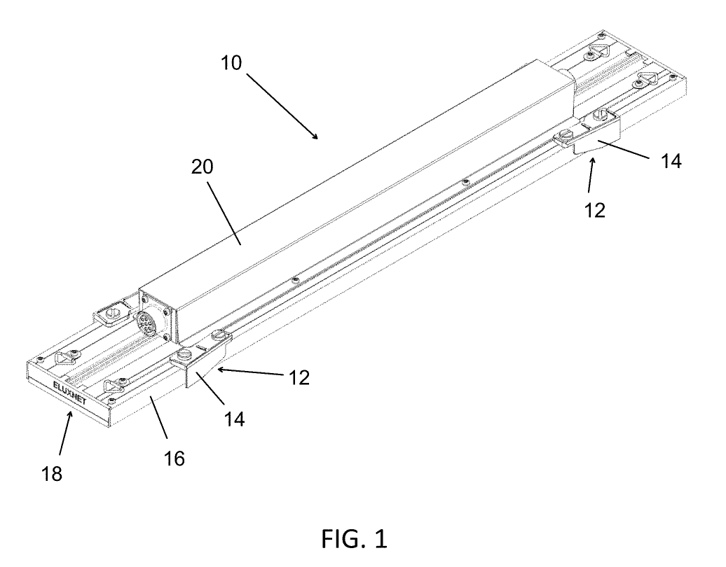

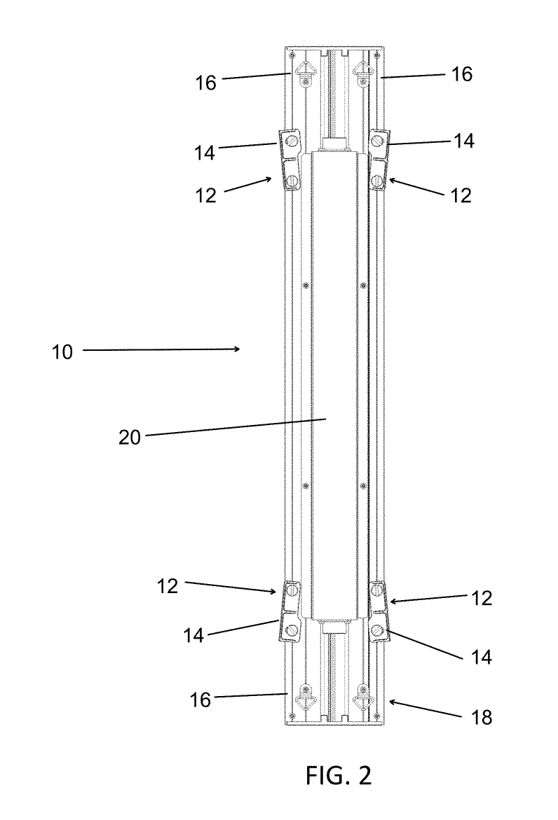

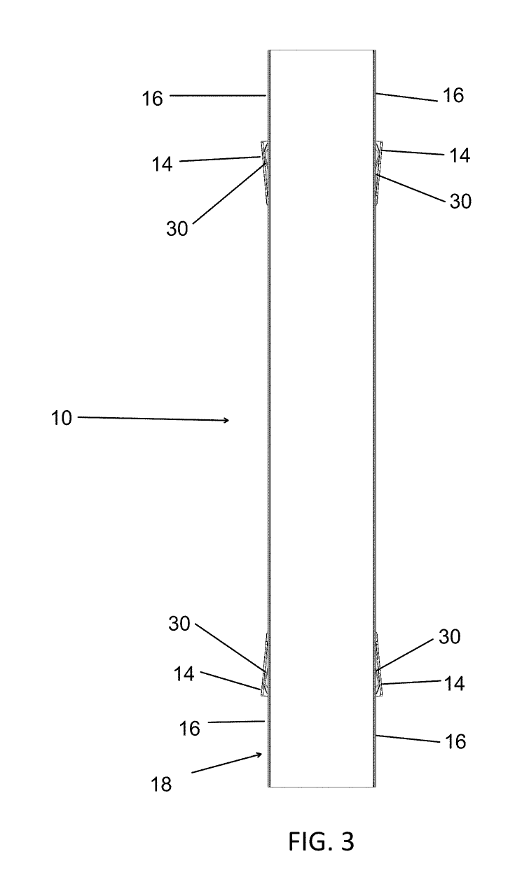

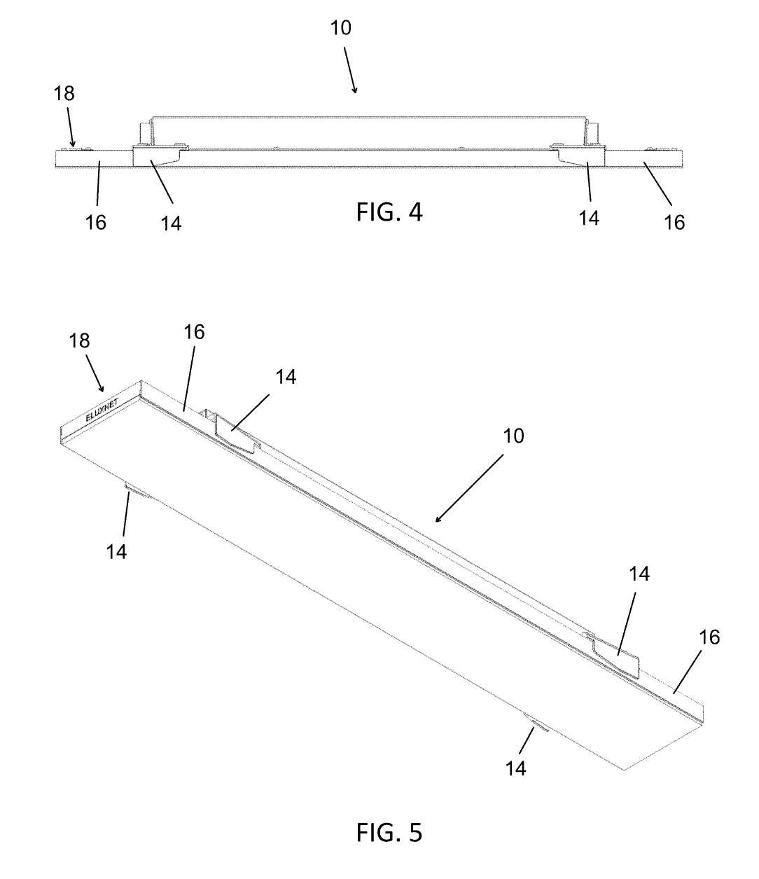

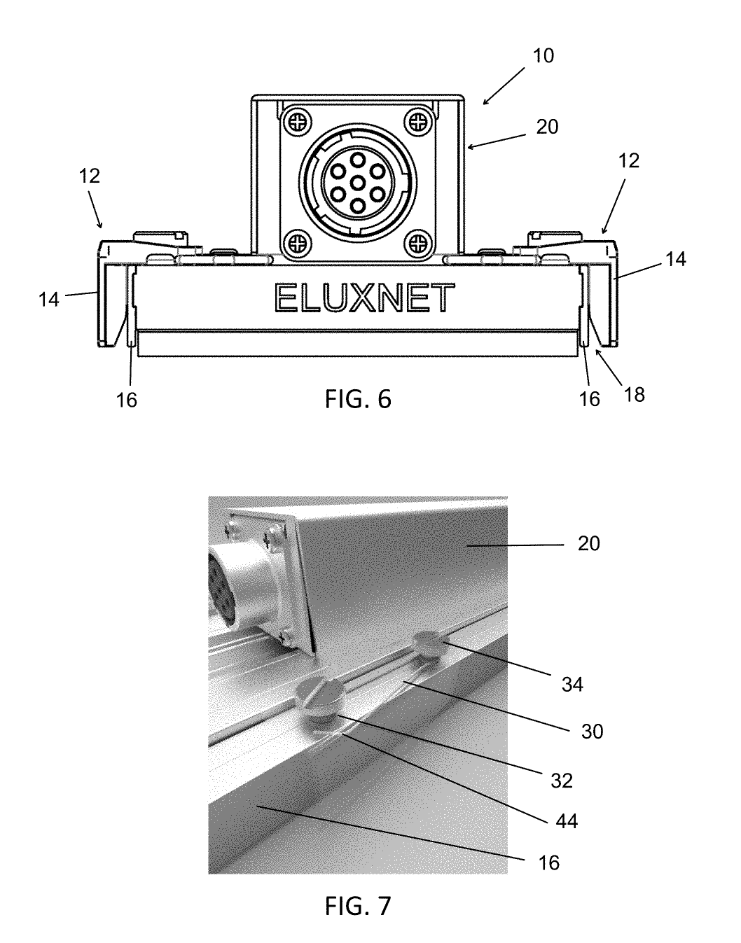

As shown in FIGS. 1-6, various views of a first embodiment of the fixture 10 of the present invention are illustrated, in which a catch mechanism 12 has a catch member 14 which pivots away from a side wall 16 of a base 18 upon which lighting electronics 20 are mounted. Referring to FIGS. 6 and 10-12, each catch member 14 pivots to engage a top surface of a portion of a fixture support member 22, so that a plurality of such catch mechanisms 12 with pivoting catch members 14 are fully supported by and engaging the fixture support member 22. Accordingly, the entire light fixture 10 is supported on or within a fixture support member 22, which is itself mounted to a ceiling and/or ceiling tiles or panels.

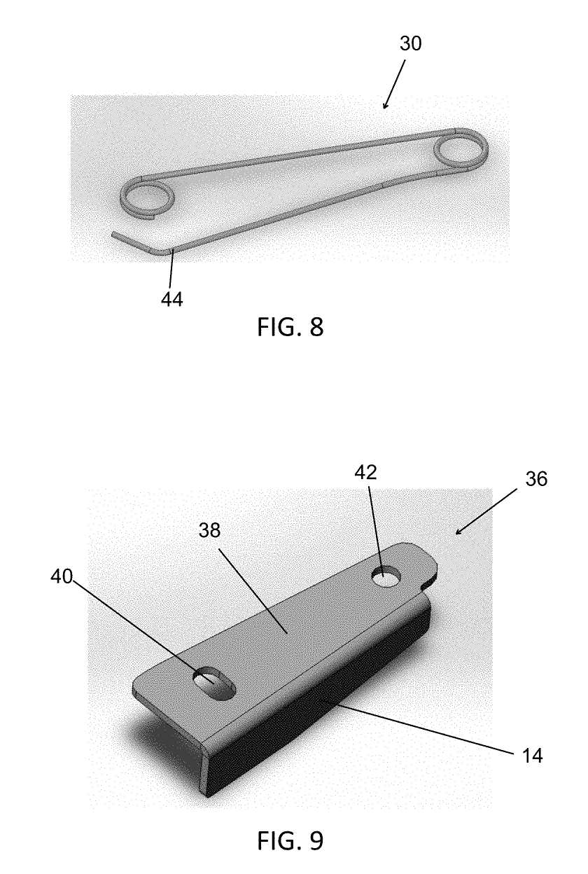

As shown in FIGS. 7-9, the elements of the catch mechanism 12 are illustrated, with a resilient member 30, which may be a spring, mounted to the side wall 16 of the base 18 by fasteners 32, 34, which may be screws. An engagement member 36 has an elongated and substantially vertical wall portion forming the catch member 14, as well as a top portion 38 in which apertures 40, 42 are formed. The first aperture 40 receives the fastener 32 in a slidable engagement, and the second aperture 42 receives the fastener 34 in a pivoting engagement. An arm 44 of the resilient member 30 engages an opposite side of the catch member 14. Accordingly, when an installer of the light fixture 10 presses the catch member 14, or when a portion of the fixture support member 22 engages the catch member 14 as the installer lifts the light fixture 10 into an opening defined by the fixture support member 22, the engagement member 36 pivots about the fastener 34 toward the side wall 16, with the arm 44 of the resilient member 30 providing a restorative force to pivot the catch member 14 away from the side wall 16. As shown in FIGS. 1-7, the pivot axis of the engagement member 36, about the fastener 34, is perpendicular to the longitudinal axis of the light fixture 10, which is simpler to assembly and manufacture with fewer parts than in light fixtures in the prior art.

In use, the installer lifts the light fixture 10 into an opening defined by the fixture support member 22, and such action causes the bottom portions of one or more of the catch members 14 to engage a portion of the fixture support member 22, which pivots the catch members 14 inward towards the side walls 16 of the base 18 of the light fixture 10. Alternatively, the installer selectively presses and pivots the catch members 14 inwards toward the side walls 16.

After the catch members 14 are sufficiently above the fixture support member 22, as shown in FIGS. 6 and 10-12, the catch members 14 no longer engage the fixture support member 22, and the restorative forces of the resilient members 30 against a side portion of each catch member 14 pivots the catch members 14 away from the side walls 16 of the base 18. Each catch member 14 pivots to the configurations shown in FIGS. 1-6 and 10-12 to have a bottom portion of each catch member 14 engage a top surface of a portion of a fixture support member 22, so that a plurality of such catch mechanisms 12 with pivoting catch members 14 are fully supported by and engaging the fixture support member 22. Accordingly, the entire light fixture 10 is supported on or within a fixture support member 22, which is itself mounted to a ceiling and/or ceiling tiles or panels.

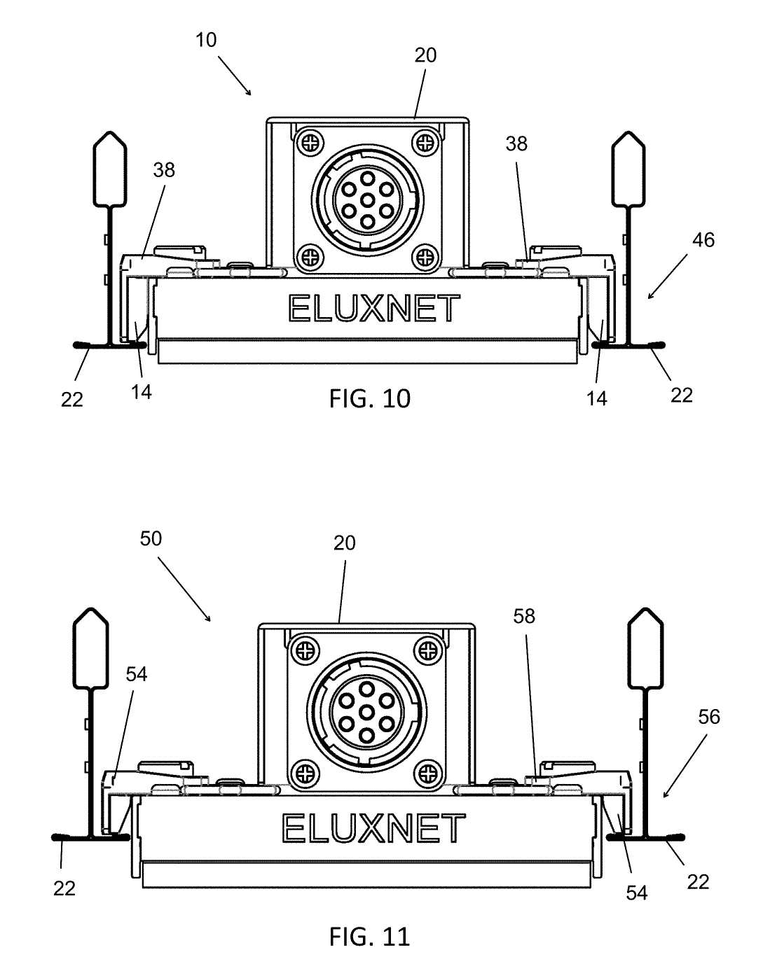

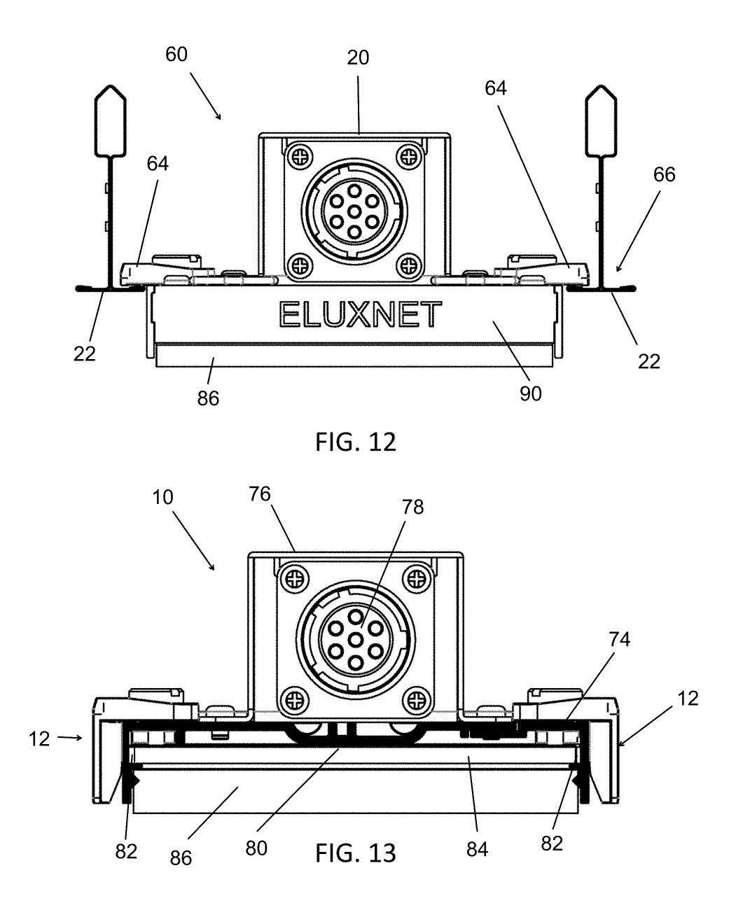

Referring to FIGS. 10-12, the vertical length of the catch members 14 determines the degree in which the light fixture 10 is recessed in the ceiling. FIG. 10 is a front plan view of the fixture in a fully recessed configuration, FIG. 11 is a front plan view of the fixture in a partially recessed configuration, and FIG. 12 is a front plan view of the fixture in a surface mounted or non-recessed configuration.

As shown in FIG. 10, for the light fixture 10, each catch member 14 extends vertically downward from the top portion 38 of the engagement member 36, shown in FIG. 9, such that the distance 46 between the top of the wall 16 of the base 18 and the fixture support member 22 is enough to cause the light fixture 10 to be substantially fully recessed within the ceiling.

As shown in FIG. 11, in an alternative embodiment, for the light fixture 50, each catch member 54 extends vertically downward from the top portion 58 of the engagement member, such that the distance 56 between the top of the wall 16 of the base 18 and the fixture support member 22 is enough to cause the light fixture 50 to be about half-recessed within the ceiling. Other degrees of recess such as two-thirds, one-third, and one-fourth may be determined by the length of each catch member 54 extending vertically downward from the top portion 58 of the engagement member.

As shown in FIG. 12, in another alternative embodiment, for the light fixture 60, the catch member has a minimal vertical length from the top portion 64 of the engagement member, and so the distance 66 between the top of the wall 16 of the base 18 and the fixture support member 22 is substantially zero, causing the light fixture 60 to be surface mounted; that is, in a non-recessed configuration.

Accordingly, the present invention is capable of being implemented with diverse configurations in the degree of recess of the light fixtures, providing different and customizable implementations of light fixtures with selectable aesthetic value.

Referring again to FIGS. 1, 6, and 9, to disengage the light fixture 10 from the ceiling, a de-installer can easily insert a thin and rigid member into the space between the side wall 16 and the fixture support member 22, and push the rigid member against the catch mechanism 12 to counter the biasing restorative force of the spring 30 against the engagement member 36, to have the engagement member 36 substantially flush with the side wall 16. The de-installer would repeat this procedure for each of the catch mechanisms 12 attached to the side walls 16 of the light fixture 10. The de-installer then allows the light fixture 10 to slide down and out of the ceiling and the fixture support member 22 due to the force of gravity.

FIG. 13 is a partial sectional view of the fixture 10 of FIG. 6, shown without the catch member 14. A frame 74 supports the catch mechanisms 12 as well as the lighting electronics 20, which is protected by a cover 76. The lighting electronics 20 may be light emitting diode (LED) drivers which are connected to pin connectors 78, such as MC cable pin connectors, for further connection to a power source and other electrical components. The LED drivers provide electrical power to control and activate an LED 82 for sending light into a light guide plate (LGP) 84 to illuminate the LGP 84.

The light from the LGP 84 is further diffused by a diffuser plate 86, which acts as a lens for emitting substantially uniform light from the light fixture 10. The diffuser plate 86 extends below the frame 74 and an end cap 90 (see, e.g., FIG. 12), and therefore can be mounted side-by-side without showing a break, which emits substantially uniform light along the length of the light fixture 10.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A catch mechanism comprising:
a resilient member; and
an engagement member having:
a top portion pivotally engaging a fastener which pivotally fastens the engagement member to a side wall of a light fixture; and
a catch member extending substantially vertically from the top portion and including:
a side wall portion engaging the resilient member; and
a bottom portion engaging a light fixture support member;
wherein the resilient member applies a restorative force to the catch member to bias the catch member away from the side wall to cause the bottom portion of the catch member to engage the light fixture support member.

2. The catch mechanism of claim 1, wherein a pivot axis of the top portion is substantially perpendicular to a longitudinal length of the light fixture.

3. The catch mechanism of claim 1, wherein the fastener is a screw for pivotally fastening the top portion of the engagement member to the side wall.

4. The catch mechanism of claim 1, wherein the fastener retains the resilient member proximate to the side wall.

5. The catch mechanism of claim 1, wherein the catch member has a vertical dimension with a length to cause the light fixture to be substantially recessed within a ceiling.

6. The catch mechanism of claim 1, wherein the catch member has a vertical dimension with a length to cause the light fixture to be partially recessed within a ceiling.

7. The catch mechanism of claim 1, wherein the catch member has a vertical dimension with a length to cause the light fixture to not be recessed within a ceiling.

8. A light fixture comprising:
a base having a side wall;
lighting electronics mounted on the base; and
a catch mechanism including:
a resilient member; and
an engagement member having:
a top portion pivotally engaging a fastener which pivotally fastens the engagement member to the side wall; and
a catch member extending substantially vertically from the top portion and including:
a side wall portion engaging the resilient member; and
a bottom portion engaging a light fixture support member;
wherein the resilient member applies a restorative force to the catch member to bias the catch member away from the side wall to cause the bottom portion of the catch member to engage the light fixture support member.

9. The light fixture of claim 8, wherein a pivot axis of the top portion is substantially perpendicular to a longitudinal length of the light fixture.

10. The light fixture of claim 8, wherein the catch member has a vertical dimension with a length to cause the light fixture to be substantially recessed within a ceiling.

11. The light fixture of claim 8, wherein the catch member has a vertical dimension with a length to cause the light fixture to be partially recessed within a ceiling.

12. The light fixture of claim 8, wherein the catch member has a vertical dimension with a length to cause the light fixture to not be recessed within a ceiling.

13. The light fixture of claim 8, further comprising:
a light-emitting element controlled by the light electronics;
a light guide member, disposed below the base, for directing light emitted by the light-emitting element.

14. The light fixture of claim 13, further comprising:
a diffuser member, disposed below the light guide member, for diffusing the light from the light guide member.

15. An assembly comprising:
a base having a side wall;
lighting electronics mounted on the base;
a fastener;
a resilient member; and
a catch mechanism including:
an engagement member having:
a top portion pivotally engaging the fastener which pivotally fastens the engagement member to the side wall; and
a catch member extending substantially vertically from the top portion and including:
a side wall portion engaging the resilient member; and
a bottom portion engaging a light fixture support member;
wherein the resilient member applies a restorative force to the catch member to bias the catch member away from the side wall to cause the bottom portion of the catch member to engage the light fixture support member.

16. The assembly of claim 15, wherein a pivot axis of the top portion is substantially perpendicular to a longitudinal length of the light fixture.

17. The assembly of claim 15, wherein the fastener retains the resilient member proximate to the side wall.

18. The assembly of claim 15, wherein the catch member has a vertical dimension with a length to cause the light fixture to be substantially recessed within a ceiling.

19. The assembly of claim 15, wherein the catch member has a vertical dimension with a length to cause the light fixture to be partially recessed within a ceiling.

20. The assembly of claim 15, wherein the catch member has a vertical dimension with a length to cause the light fixture to not be recessed within a ceiling.
